(19) United States
(12) Patent Application Publication
(10) Pub. No.: US 2026/0033663 A1
(43) Pub. Date: Feb. 5, 2026

(54) METHOD FOR A USER-CONTROLLED DETERMINATION OF THE DEGREE OF ROASTING OF COFFEE BEANS FOR PREPARING A COFFEE BEVERAGE BY MEANS OF A COFFEE MACHINE

(71) Applicant: BSH Hausgeräte GmbH, München (DE)

(72) Inventors: Otto KRAUTENBACHER, Palling (DE); Josef DABURGER, Siegsdorf (DE); Florian EDER, Pittenhart (DE)

(21) Appl. No.: 19/099,148

(22) PCT Filed: Jul. 4, 2023
(86) PCT No.: PCT/EP2023/068387

§ 371 Date: Jan. 28, 2025

(30) Foreign Application Priority Data
Jul. 28, 2022 (DE) 10 2022 207 812.8

(51) Int. Cl. A47J 31/52; A23F 5/04; A47J 31/42

(52) U.S. Cl. CPC A47J 31/521; A23F 5/04; A47J 31/42

(57) ABSTRACT

A method for a user-controlled operation of a coffee machine for preparing a coffee beverage from coffee beans. By answering multiple questions relating to the coffee beans to be used by way of a user interaction, a degree of roasting is selected from at least two specified reference degrees of roasting and is transmitted to the coffee machine. In response thereto, coffee beans with the selected degree of roasting are used by the coffee machine in the course of the preparation of the coffee beverage.

The present invention relates to a method for the user-controlled determination of a degree of roasting of coffee beans for preparing a coffee beverage by means of a coffee machine. The invention relates moreover to a coffee machine arrangement, which is configured/programmed to carry out this method, and a corresponding computer program product.

A method for the user-controlled production of a food product, in particular a liquid food product, is known from EP 2 279 683 A1, in which an automatic machine extracts flavoring substances that can be perceived gustatorily, olfactorily and/or haptically from a precursor product and transfers them into the food product. In this process, the extraction of the flavoring substances is influenced by a user-controlled setting of at least two technical parameters of the automatic machine in order to be able to produce a desired quality of the food product. The necessary technical parameters are set by a user-controlled electronic translation circuit, which controls the technical parameters during production based on user-selected values of the human sensory attributes and a previously determined sensory profile of the precursor product. This should allow a desired taste, aroma or texture of the food product to be set more precisely.

WO 622/003743 A1 discloses an automatic coffee machine for preparing coffee beverages by infusing coffee powder, which has a control and monitoring facility configured to adjust at least one operating parameter of a pre-infusion step and to select it from: a flow rate of the pre-infusion water, an amount of the pre-infusion water and a duration of the pause at the end of the pre-infusion step, and this in dependence on a granulometry of the coffee powder.

In conventional coffee machines, the user can often choose between different degrees of roasting of the coffee beans for the preparation of the coffee product.

However, the selectable degrees of roasting are not linked to other preparation parameters that are more familiar to the user, such as the preferred type of bean, the desired type of coffee and the desired flavor of the bean, so that the user is unable or only with difficulty able to estimate which degree of roasting is required in order to obtain the coffee product with the desired properties.

The object of the present invention is to provide an improved method for the user-controlled determination of a degree of roasting of coffee beans, in which this disadvantage is eliminated.

This object is achieved in accordance with the invention by the subject of the independent claims. Advantageous embodiments are the subject of the dependent claims.

The basic idea is therefore to determine an optimum degree of roasting for the preparation of a coffee product by a coffee machine with the help of a list of questions containing questions regarding the desired coffee product, in particular regarding various properties of the coffee beans to be roasted. In this process, at least two answer choices are defined for each question, from which a user can select to answer the respective question. Depending on the answers selected by the user, a specific degree of roasting can thus be selected from predefined reference degrees of roasting, wherein the individual answer choices are linked to at least one of the predefined reference degrees of roasting. Based on this linking, the particular reference degree of roasting which is optimal and consequently the degree of roasting which is to be selected for the coffee preparation can be the particular one of the predetermined reference roasting degrees which is assigned the largest number of answer choices selected by the user when answering the list of questions.

The method in accordance with the invention is used for the user-controlled determination of a degree of roasting of coffee beans for preparing a coffee beverage by means of a coffee machine. In detail, in accordance with the method, a degree of roasting is selected by means of user interaction from at least two predetermined reference degrees of roasting by answering multiple questions, which relate to the coffee beans to be used, and transmitted to the coffee machine.

Thereupon, in the course of preparing the coffee beverage, coffee beans with the selected degree of roasting are used by the coffee machine. In particular, this means that, in the course of preparing the coffee beverage, one of multiple different preparation parameter sets can be used which is adapted, in particular optimally, for preparing the coffee beverage with the selected and transmitted degree of roasting, or is at least better adapted than the other preparation parameter sets. In particular, each of the preparation parameter sets can include a specific grinding setting for a grinder that can be adjusted, preferably automatically.

In a preferred embodiment of the method in accordance with the invention, at least two different reference degrees of roasting are predefined. In addition, at least two questions are predefined. At least two answer choices are predefined for each predefined question, wherein each answer choice is assigned at least one of the predefined reference degrees of roasting. In this way, the individual questions and the predetermined answer choices assigned to these questions are linked to specific reference degrees of roasting, so that the answer choice selected by the user takes into account the selection of the correct reference degree of roasting as the degree of roasting for the coffee preparation.

According to an advantageous development of the method in accordance with the invention, this comprises two measures a) and b). In measure a), the predetermined questions are displayed to a user in a display unit. According to measure b), one of the at least two different reference degrees of roasting is selected as the degree of roasting to be transmitted to the coffee machine, and in fact depending on the answer choices selected by the user by means of an input unit in response to the individual questions, which are successively displayed in measure a).

It is particularly useful that the user can select two or more of the predetermined answer choices when answering at least one question, preferably when answering all the questions. This allows the list of questions to be designed more flexibly with the questions to be answered.

According to a further advantageous development of the method in accordance with the invention, in the course of measure b) in a first sub-measure b1), the respective number of answer choices selected by the user in total, said answer choices being assigned to the respective reference degree of roasting, is determined for each reference degree of roasting. In a second sub-measure b2) of the measure b) following the first sub-measure b1), the particular reference degree of roasting selected as the degree of roasting is the one for which the largest number of answer choices assigned to this reference degree of roasting was determined in sub-measure b1).

In a further preferred embodiment, at least one of the predetermined questions relates to a type of coffee to be produced using the coffee beans. Alternatively or additionally, in this embodiment, at least one of the predetermined questions relates to a desired brightness of the coffee beans. Alternatively or additionally, in this embodiment, at least one of the predetermined questions relates to the type of bean to be used. Alternatively or additionally, in this embodiment, at least one of the predetermined questions relates to the flavor of the coffee beans to be used.

Particularly preferably, at least five reference degrees of roasting, preferably at least the following five reference degrees of roasting, can be predefined: very light roast; light roast; medium roast, i.e. balanced; dark roast, i.e. intense/spicy; very dark roast, i.e. distinctive/strong/powerful.

Preferably, the method can be carried out in a cellphone, wherein the display facility and the input unit can particularly preferably be formed by a touch-sensitive display of the cellphone.

According to a further advantageous development, the degree of roasting determined in measure b), in particular by assigning a name, is preferably stored in the cellphone before the degree of roasting is transmitted to the coffee machine.

The invention also relates to a coffee machine arrangement with a coffee machine for preparing a coffee product from coffee beans, wherein the coffee machine is configured to produce the coffee product from coffee beans with at least two different degrees of roasting. Furthermore, the arrangement in accordance with the invention comprises a facility which is configured/programmed to carry out the method in accordance with the invention presented above and which can be connected or is connected to the coffee machine in a data-transmitting manner in order to transmit the determined degree of roasting to the coffee machine. The advantages of the method in accordance with the invention explained above are therefore transferred to the arrangement in accordance with the invention.

In another preferred exemplary embodiment of the arrangement in accordance with the invention, the facility is or comprises a cellphone.

Further important features and advantages of the invention are apparent from the sub-claims, from the drawings and from the associated description of the figures with reference to the drawings.

It is understood that the features mentioned above and those to be explained below can be used not only in the combination indicated in each case, but also in other combinations or on their own, without departing from the scope of the present invention.

A preferred embodiment of the invention is shown in the drawings and is explained in more detail in the following description.

In the drawing, in each case schematically:

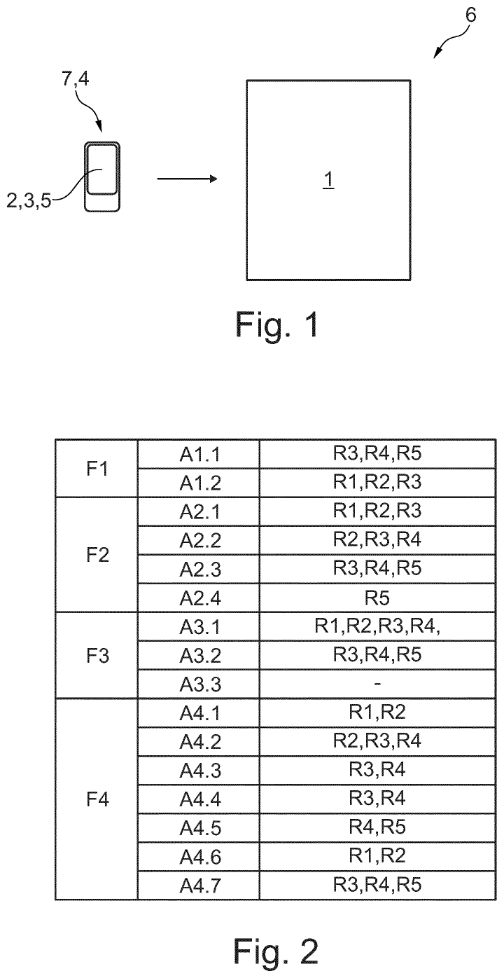

FIG. 1 shows by way of example an arrangement in accordance with the invention,

FIG. 2 shows a table which illustrates the method in accordance with the invention and demonstrates the linking of various predetermined answer choices to a respective question of a list of questions with possible reference degrees of roasting,

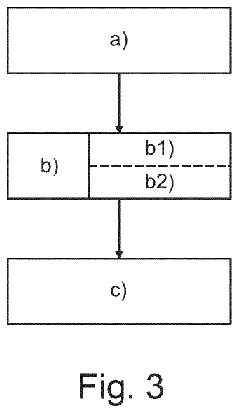

FIG. 3 shows a flow chart of the method in accordance with the invention.

FIG. 1 illustrates a simplified, rough schematic representation of an example of a coffee machine arrangement 6 in accordance with the invention. This arrangement 6 comprises an extremely simplified coffee machine 1 for preparing a coffee product from coffee beans. The coffee machine 1 is designed to produce the coffee product from coffee beans with at least two different degrees of roasting RG. Furthermore, the arrangement in accordance with the invention comprises a facility 7 that is configured and programmed to carry out the method in accordance with the invention. In the example, the facility 7 is a cellphone 4.

The cellphone 4 is connected to the coffee machine 1 in a data—transmitting manner—preferably by means of a wireless data connection such as “Bluetooth”—in order to transmit the degree of roasting RG determined with the help the method in accordance with the invention to the coffee machine 1.

In the following, the method in accordance with the invention is explained by way of example with reference to FIGS. 2 and 3.

The method in accordance with the invention is used for the user-controlled determination of a degree of roasting of coffee beans for preparing a coffee beverage by means of a coffee machine. According to the method, by answering four questions F1-F4 relating to the coffee beans to be used, a specific degree of roasting RG is determined from five predetermined reference degrees of roasting R1-R5 by means of user interaction and transmitted to the coffee machine 1. Coffee beans with the selected degree of roasting RG are then used by the coffee machine 1 in the course of preparing the coffee beverage.

In the example, at least the following five reference degrees of roasting R1 to R5 are predefined: very light roasting R1, light roasting R2; medium roasting R3; dark roasting R4; very dark roasting R5.

In addition, four questions F1 to F4 are predefined in the example, which relate to the coffee beans to be used. For each predefined question, two answer choices A1.1, A1.2, A2.1, A2.2, A2.3, A2.4, A3.1, A3.2, A3.3, A4.1, A4.2 are predefined, wherein these answer choices are assigned to at least one of the predefined reference degrees of roasting R1-R5.

For example, a first question F1 can relate to the type of beverage to be produced. A first answer choice A 1.1 can then be “Espresso”, for example, and a second answer choice A1.2 can be “Caffè Crema”. A second question F2 can also relate to the brightness of the coffee beans to be used. For example, a first answer choice A2.1 may be “light”, a second answer choice A2.2 may be “medium”, a third answer choice A2.3 may be “dark” and a fourth answer choice A2.4 may be “very dark”. Furthermore, a third question F3 can relate to the type of coffee bean to be used. A first answer choice A3.1 can then be “40% Arabica”, a second answer choice A3.2 “Arabica, robust blend”, a third answer choice A3.3 can be “no specification”. Furthermore, a fourth question F4 can relate to the type of coffee bean to be used. The following seven possible answer choices A4.1-A4.7 are conceivable: A4.1: fruity; A4.2: chocolaty; A4.3: nutty; A4.4: caramel; A4.5: spicy; A4.6: mild; A4.7: intense.

According to the table shown in FIG. 2, each of the answer choices A1.1, A1.2, A2.1-A2.4, A3.1-A3.3, A4.1-A4.7 is assigned to at least one of the reference degrees of roasting R1 to R5.

According to the flow chart, the method in accordance with the invention comprises the three measures a) and b) in the example. In measure a), the predetermined four questions F1-F4 are displayed to the user in the display unit 2. According to measure b), one of the five different reference degrees of roasting R1-R5 is selected as the degree of roasting RG to be transmitted to the coffee machine 1, and in fact depending on the answer choices A1.1, A1.2, A2.1-A2.4, A3.1-A3.3, A4.1-A4.7 selected by the user in response to the individual questions displayed in succession in measure a). The user selects the individual answer choices A1.1, A1.2, A2.1-A2.4, A3.1-A3.3, A4.1-A4.7 by means of the input unit 3.

As can be seen with the aid of the above example or from the table according to FIG. 2, multiple answers can optionally also be provided when answering individual or all of the questions F1-F4.

In the course of measure b), the respective number n1-n5 of answer choices A1.1, A1.2, A2.1-A2.4, A3.1-A3.3, A4.1-A4.7 selected by the user in total, said answer choices being assigned to the respective reference degree of roasting R1-R5, is determined for each reference degree of roasting R1-R5 in a first sub-measure b1) (see table in FIG. 2). In a second sub-measure b2) of the measure b) following the first sub-measure b1), the particular one of the five reference degrees of roasting R1-R5 selected as the degree of roasting RG is the one for which the largest number n1-5 of answer choices A1.1, A1.2, A2.1-A2.4, A3.1-A3.3, A4.1-A4.7 assigned to this respective reference degree of roasting R1-R5 was determined in the sub-measure b1.

From the example according to the table in FIG. 2, n1=5, n2=7, n3=11, n4=10, n5=6. Since the value of n3 is greater than the values n1, n2, n4 and n5, the reference degree of roasting R3 is selected in the example as the degree of roasting RG to be transmitted to the coffee machine 1.

The degree of roasting RG determined in measure b) can be stored in the cellphone 4 or elsewhere by assigning a name before the degree of roasting is transmitted to the coffee machine 1.

The display facility 2 and the input unit 3 can be formed by a touch-sensitive display 5 of the cellphone 4.

### REFERENCE CHARACTERS

1 Coffee machine
2 Display facility
3 Input unit
4 Cellphone
5 Display
6 Coffee machine arrangement
7 Facility
F1-F4 Questions
A1.1, A1.2, A2.1-A2.4, Answer choices
A3.1-A3.3, A4.1-A4.7 Answer choices
R1-R5 Reference degrees of roasting
RG Degree of roasting

1-12. (canceled)

13. A method for a user-controlled determination of a degree of roasting of coffee beans for preparing a coffee beverage by a coffee machine, the method comprising:
selecting a degree of roasting, by way of user interaction, from at least two predetermined reference degrees of roasting by answering multiple questions, which relate to the coffee beans to be used, and transmitting to the coffee machine; and
using, or preparing and using, coffee beans with the selected degree of roasting by the coffee machine in a course of preparing the coffee beverage.

14. The method according to claim 13, wherein:
at least two different reference degrees of roasting are predefined;
at least two questions are predefined and each predefined question has at least two predetermined answer choices, and at least one of the predefined reference degrees of roasting is assigned to each of the answer choices.

15. The method according to claim 14, wherein the at least two questions relate to the coffee beans to be used or to be prepared and used.

16. The method according to claim 14, which further comprises:
a) successively displaying the predefined questions on a display unit; and
b) selecting one of the at least two different reference degrees of roasting as the degree of roasting to be transmitted to the coffee machine in dependence on the answer choices selected by the user in response to the individual questions by way of an input unit.

17. The method according to claim 14, which comprises, for answering at least one question, enabling the user to select two or more of the predetermined answer choices.

18. The method according to claim 17, which comprises enabling the user to select two or more of the predetermined answer choices for all of the at least two questions.

19. The method according to claim 16, wherein method step b) further comprises:
determining, in a sub-step b1), for each reference degree of roasting, a respective number of answer choices selected by the user in total that are assigned to the respective reference degree of roasting; and
selecting, in a sub-step b2), the particular reference degree of roasting selected as the degree of roasting with the greatest number of answer choices selected by the user in sub-step b1) as the chosen degree of roasting.

20. The method according to claim 14, wherein at least one of the following is true:
at least one of the predefined questions relates to a type of coffee to be produced using the coffee beans;
at least one of the predefined questions relates to a desired brightness of the coffee beans;
at least one of the predefined questions relates to a type of coffee bean to be used;
at least one of the predefined questions relates to a flavor of the coffee beans to be used.

21. The method according to claim 13, wherein at least five reference degrees of roasting are predefined, the at least five reference degrees of roasting being selected from the group consisting of:
very light roast;
light roast;
medium roast, namely, balanced;
dark roast, namely, intense, spicy; and
very dark roast, namely, distinctive, strong, powerful.

22. The method according to claim 13, which comprises effecting the user interaction via a mobile phone, wherein the display facility and the input unit are formed by a touch-sensitive display of the mobile phone.

23. The method according to claim 16, which comprises effecting the user interaction via a mobile phone, and storing the degree of roasting determined in method step b) in the mobile phone before the degree of roasting is transmitted to the coffee machine.

24. The method according to claim 23, which comprises assigning a name to the degree of roasting stored in the mobile phone.

25. A coffee machine arrangement, comprising:
a coffee machine for preparing a coffee product from coffee beans, said coffee machine being configured to produce the coffee product from coffee beans with at least two different degrees of roasting; and
a facility configured to carry out the method according to claim 13, said facility being connected or connectible to said coffee machine for data transmission in order to transmit the determined degree of roasting to said coffee machine.

26. The arrangement according to claim 25, wherein said facility comprises a mobile phone.

27. A non-transitory computer program product, comprising instructions that cause a coffee machine arrangement having a coffee maker that is configured to produce a coffee product from coffee beans with at least two different degrees of roasting to perform the method according to claim 13.
